(19) United States
(12) Patent Application Publication
(10) Pub. No.: US 2005/0099535 A1
(43) Pub. Date: May 12, 2005

(54) Apparatus and method capable of processing data

(76) Inventors: Jin-woo Yu, Suwon-si (KR); Charm-han Ko, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/946,123

(22) Filed: Sep. 22, 2004

(30) Foreign Application Priority Data
Nov. 12, 2003 (KR) 2003-79684

(51) Int. Cl. H04N 11/20; H04N 5/50; H04N 7/00; H04N 7/084; H04N 9/76

(52) U.S. Cl. 348/447; 348/910; 348/569; 348/468; 348/474; 348/600

(57) ABSTRACT

A data processing apparatus and method are disclosed. The apparatus and method comprise receiving a selection signal for a first mode of a plurality of color modes set in order to implement the information menu displayed as a plurality of pixels each having a first index. Identifying information is stored for a palette mapped to the selected first mode of a plurality of palettes stored for each of the plurality of color modes. Each of second indexes mapped to the each first indexes provided are stored for each color of the pixels from the palette corresponding to the stored identifying information when a display request signal for the information menu is received. The information menu is generated as a displayable signal using the read second indexes.

This application claims the benefit under 35 U.S.C. § 119(a) of Korean Patent Application No. 2003-79684, filed on Nov. 12, 2003, the entire contents of which are incorporated herein by reference.

### BACKGROUND OF THE INVENTION

1. Field of the Invention

The present invention relates generally to an apparatus and method for processing data. More particularly, the present invention relates to an apparatus and method for processing data, which is capable of eliminating flickering by selecting a specific color mode from a plurality of color modes displaying an information providing menu such as an On Screen Display (OSD), converting the menu into the selected color mode and then displaying the menu having the converted color mode on a screen.

2. Description of the Related Art

A digital video disc player (DVDP) is a device for reproducing data written on an optical disc such as a DVD, and provides a high and quality image because the optical disc digitizes and records video data so that the DVDP may reproduce the data in a digital manner. In addition, the DVDP provides an information menu that allows the user to set various functions and status supported by the DVDP in a bright and distinct color. The information providing menu is a guide message displayed on a TV connected to the DVDP and may, for example, include an OSD menu and a Graphics User Interface (GUI) menu.

If a DVDP is connected to a digital TV such as a Liquid Crystal Display (LCD) TV, Plasma Display Panel (PDP) TV, or the like, the video data and the OSD menu that are reproduced from DVDP can be implemented as a high definition image. However, if the DVDP is connected to a conventional Cathode Ray Tube (CRT) TV, which has a lower image quality than a LCD TV, the image quality of the OSD menu that is reproduced from the DVDP is degraded. In other words, when the OSD menu provided by the DVDP is displayed on the CRT TV, severe flickering is introduced on the CRT TV because the OSD menu has been subjected to graphic-processing so that it may be implemented to conform to the color and image performance of the DVDP.

Recently, in order to overcome the flickering generated in a CRT TV displaying DVDP information, the OSD menu provided by DVDPs are implemented with a lower color brightness. This is because CRT TVs having low performance are currently more numerous relative to high performance TVs such as LCD TVs and PDP TVs. Unfortunately, if a user has a high performance TV and DVDP, the user views the degraded OSD menu in spite of having a high performance TV.

Accordingly, there is presently a need for an apparatus and method that eliminates flickering in a TV set connected to a DVDP.

### SUMMARY OF THE INVENTION

The present invention has been developed in order to solve the above drawbacks and problems associated with the conventional arrangement. The object of the present invention is to provide an apparatus and a method for processing data wherein flickering generated when an information menu such as an On Screen Display (OSD) is displayed on the screen can be eliminated and the OSD can be displayed differently based on the characteristics of the TV connected to the DVDP, thereby improving the image quality of the OSD menu.

In order to overcome the foregoing problems, the apparatus and method for processing data according to an embodiment of the present invention is characterized by implementing an information menu conforming to the characteristics of the TV.

More specifically, when the additional information providing menu implemented as a Red Green Blue (RGB) format is converted into a luminance information and chrominance information (YIQ) format and displayed in the data processing apparatus, it is possible to select a specific color mode out of a plurality of color modes (that is, a pluralities of palettes) that are set differently using a certain brightness difference and then convert the menu into a YIQ format. In particular, in the case where the display device connected to the data processing apparatus is a Cathode Ray Tube (CRT) TV, it is possible to overcome the flickering by selecting a color mode that is set to a darker brightness and generating the information menu.

The information menu is an OSD menu that sets the functions provided by the data processing apparatus, or a GUI menu that displays a specific guide message.

Further, in accordance with another aspect of the present invention, it is possible to add a user's color mode to the plurality of color modes described above based on the user's color preference. Specifically, when a given number of the user' preference colors are selected out of a plurality of the user's colors stored on a prescribed storage medium in the data processing apparatus, it is possible to generate and add the user's color mode comprising the user's selected reference of colors.

Here, the RGB format and the YIQ format that are set in the initial data processing apparatus can be changed and applied to other color formats depending on the specifications of the data processing apparatus.

### BRIEF DESCRIPTION OF THE DRAWINGS

The above aspects and features of the present invention will be more apparent by describing embodiments of the present invention with reference to the accompanying drawings, in which:

FIG. 1 is a view illustrating an example of a display system to which the data processing apparatus is applied according to an embodiment of the present invention;

FIG. 2 is a block diagram illustrating an optical reproducing apparatus to which the data processing apparatus shown in FIG. 1 is applied;

FIG. 3 is a flow chart illustrating a data processing method using the optical reproducing apparatus shown in FIG. 2;

FIG. 4 is a block diagram illustrating an example of a mode selection screen capable of selecting a color mode for displaying an information screen;

FIG. 5A is a diagram illustrating an example of an additional information providing menu implemented as the first color mode set in FIG. 2; and

FIG. 5B is a diagram illustrating an example of an information menu implemented as the second color mode set in FIG. 2.

Throughout the drawings, it should be noted that the same or similar elements are denoted by like reference numerals.

### DETAILED DESCRIPTION OF THE PREFERRED EMBODIMENTS

Embodiments of the present invention will now be described in greater detail with reference to the accompanying drawings.

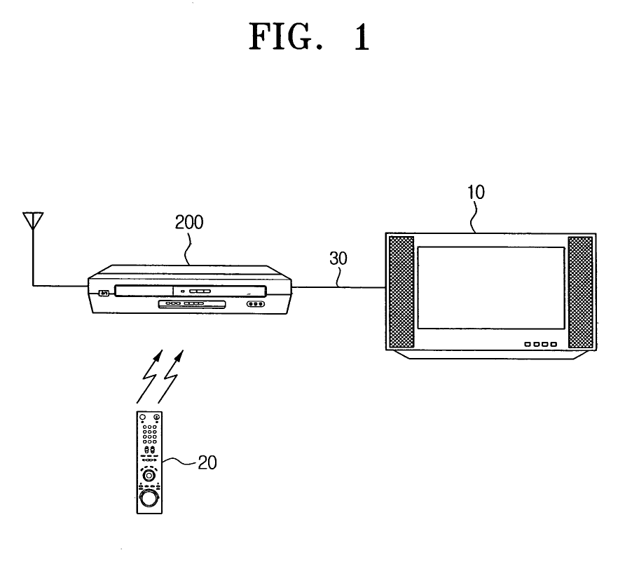

FIG. 1 is a view illustrating an example of the display system to which the data processing apparatus is applied according to an embodiment of the present invention.

With reference to FIG. 1, the data processing apparatus 200 according to an embodiment of the present invention is connected to a display device 10, which is generally a TV, via a transmitting cable 30. The data processing apparatus 200 processes signals received from a user interface such as a remote controller 20, processes display information as a reproducible signal, and then sends the processed signal to the TV 10.

The display information, may include, for example, image/sound data supplied from an image source, and data associated with the information menu. The image source includes an optical disc, a digital satellite broadcasting system, a terrestrial wave broadcasting system, and a cable broadcasting system. The information menu is implemented as an On Screen Display (OSD) menu, a Graphical User (GUI) menu, and the like, and includes, for example, an additional mode screen (not shown) and a mode selection screen 400 described below.

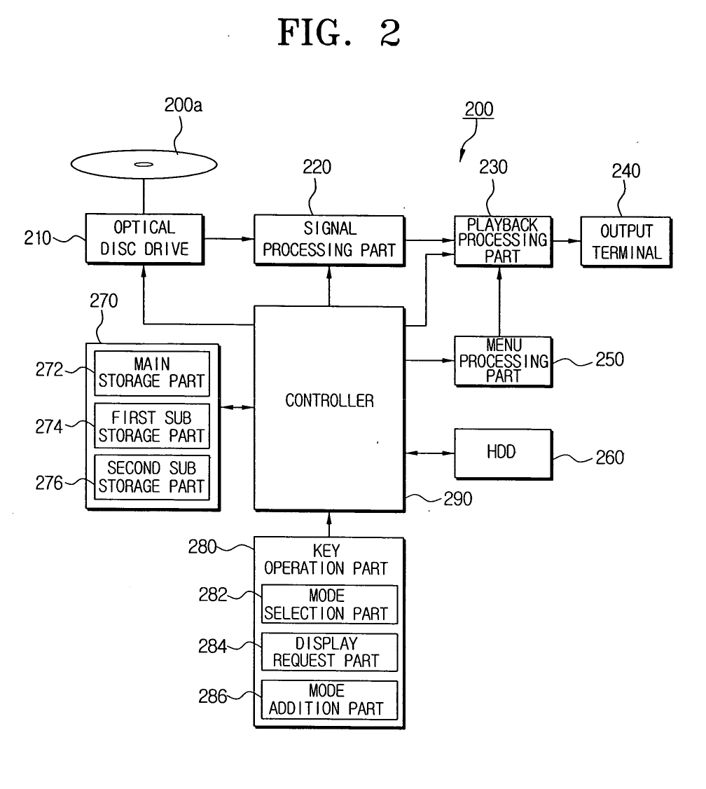

FIG. 2 is a block diagram schematically illustrating the optical reproducing apparatus to which the data processing apparatus shown in FIG. 1 is applied.

With reference to FIG. 2, the optical reproducing apparatus 200 according to a first embodiment of the present invention comprises an optical disc drive 210, a signal processing part 220, a playback processing part 230, an output terminal 240, a menu processing part 250, a hard disk drive (hereinafter, referred to as “HDD”) 260, a storage part 270, a key operation part 280 and a controller 290.

The optical reproducing apparatus 200 is a data processing apparatus for processing moving image data written on an optical disc 200a or HDD 260 as a reproducible signal and providing the signal to the TV 10, and for simplicity of explanation, only the blocks associated with an embodiment of the present invention are shown.

For example, the optical reproducing apparatus 200 may include a digital video disk player (DVDP), a digital video disk recorder (DVDR), and a digital video disk recorder (DVDR). The optical disc 200a may include a DVD and a CD by way of an example. Such an optical reproducing apparatus 200 generates an actual image, the additional mode screen (not shown), and the mode selection screen 400 as a reproducible signal, and provides these to the TV 10.

The optical disk drive 210 detects the moving image data written on the optical disc 200a using a pickup (not shown). The pickup (not shown) converts the moving image data detected from the optical disc 200a into a radio frequency (RF signal.)

The signal processing part 220 amplifies the RF signal and converts the amplified RF signal into an electrical signal, and then digitizes the converted electrical signal.

The playback processing part 230 converts the moving image data written on the optical disc 200a or HDD 260 into a viewable signal and outputs it. More specifically, the playback processing part 230 decompresses the moving image data input from the signal processing part 220 and then processes the decompressed moving image data as the viewable signal. Also, the playback processing part 230 synthesizes a main image and a caption such as the moving image data, and a sub image such as the information menu and outputs it.

The data output from the playback processing part 230 is transmitted via the transmitting cable 30 to the TV 10 to be displayed. The transmitting cable 30 is connected to the output terminal 240.

The menu processing part 250 processes a specific information menu stored in the storage part 270 described below as a displayable signal. The information menu generated by the menu processing part 250 is provided to the playback processing part 230, and is synthesized with the moving image data or outputted alone.

HDD 260 writes and manages data having various extensions and moving image data written on the optical disc 200a by a File Allocation Table (FAT) file system.

The storage part 270 includes a main storage part 272, a first sub storage part 274, and a second sub storage part 276.

The main storage part 272 is a non-volatile memory storing control programs for controlling and managing the entire operation of the optical reproducing apparatus 200.

The first sub storage part 274 is stored with the hue index of each pixel for implementing a certain additional information providing menu. Especially, the hue index of each pixel (hereinafter, referred to as “a first index”) is stored for each additional information providing menu provided by the optical reproducing apparatus 200.

The first index is an index indicating the color of each pixel displaying the information menu, that is, the color of each bitmap. As with the present invention, when the bitmap is comprised of R (red), G (green), and B (blue) formats, the color of each bitmap is generated as 16 different colors having R, G, and B colors mixed at a certain ratio, wherein the 16 different colors are assigned the first index such as #1 through #16.

Accordingly, since one information menu is set so as to be implemented by using 16 different colors, each pixel implementing the certain additional information providing menu has any one of the first index of #1 through #16. Preferably, the first sub storage part 274 is stored with the first index assigned to each bitmap color implementing the specific additional information providing menu for each location of the pixel.

The second sub storage part 276 is stored with n palettes (a first to nth palettes, wherein n is a positive integer) for converting the color format of the additional information providing menu into a YIQ format for each color modes.

Each palette has a second index mapped into each of the first index stored in the first sub storage part 274, each palette having a plurality of differing second indexes for each color modes. The color modes can be differentiated by a brightness indicating the degree of a brightness and darkness, or a color tone.

The plurality of second indexes are an index that is set in the palette matched for the first color mode, and have an index identical to the plurality of first indexes comprising the specific information menu.

The plurality of second indexes that are set in the each palette are an index assigned to the bitmap color implemented as a YIQ format. Since the second indexes are mapped into the first index, the second sub storage part 276 is stored with 16 colors used for displaying the specific information menu, that is, the 16 second indexes assigned with indexes of #1 through #16.

Further, the palette comprising the user's plurality of colors is stored in the second sub storage part 276. The plurality of user's colors are selected according to the user's preference, and may include the colors corresponding to the plurality of second indexes. More specifically, the user selects a given number of colors of the plurality of user colors and generates a user's palette by using the mode addition part 286 described below, thereby a user's color mode corresponding to the user's palette generated thus is added to the plurality of color modes.

In addition, the identifying information of the color mode selected by the mode selection part 282 described below is stored in the second sub storage part 276. An example of the identifying information includes the position where the selected color mode is stored.

The key operation part 280 is a user interface for outputting to the controller 290 commands for setting or performing the functions supported by the optical reproducing apparatus 200. To this end, the key operation part 280 includes a plurality of operation keys such as numerical keys, directional keys, identifying keys. In accordance with an embodiment of the present invention, the key operation part 280 includes a mode selection part 282, a display request part 284, and a mode addition part 286.

The mode selection part 282 outputs a selection signal for a certain mode of a plurality of color modes set to implement the additional information providing menu. That is, the mode selection part 282 is to select a certain color mode of palette for each of the color modes stored in the first sub storage part 274.

The display request part 284 outputs a display request signal for the information menu such as the mode selection screen and the additional mode screen. The mode selection screen is a screen capable of selecting and/or setting color mode for displaying the information screen, and the additional mode screen is a screen for displaying a plurality of user's colors stored on the user's palette in the second sub storage part 276. Further, the information menu is a menu displayed as an OSD menu and a GUI menu, and is displayed as a screen that allows the user to set a guide message or the detailed functions of the optical reproducing apparatus 200. When a predetermined display request signal is output from the display request part 284, a specific information menu is generated and displayed with the color of the palette matched for the color mode selected.

The mode addition part 286 outputs selection signals for a given number of user's preference colors of the plurality of user's colors stored in the second sub storage part 276, and outputs to the controller 290 a request signal allowing the user's palette comprising the given number of user's preference colors selected to be generated. The request signal allowing the user's palette to be generated is a request signal allowing the user's color mode to be added, thus the color mode is added with the user's color mode corresponding to the user's palette generated.

The controller 290 controls the entire operation of the optical reproducing apparatus 200 according to signals generated from the key operation part 280 or the remote controller 20 and control programs stored in the main storage part 272.

In accordance with an embodiment of the present invention, when a certain first color mode selecting signal is received from the mode selection part 282, the controller 290 allows the identifying information of the palette corresponding to the first color mode selected to be stored on a given area in the second sub storage part 276.

In addition, when a display request signal for a specific additional information providing menu is received from the display request part 284, the controller 290 identifies the identifying information stored on the second sub storage part 276, and then reads out a plurality of second indexes mapped to a plurality of first indexes from the palette corresponding to the identified identifying information.

And, the controller 290 controls the menu processing part 250 and processes a specific information menu so that it may be generated as a displayable signal by using the plurality of second indexes read out. Thus, on TV 10 the first color mode selected is displayed, that is, the specific information menu implemented as the bitmap color assigned with the plurality of second indexes is displayed.

When selection signals for a given number of user's preference colors of the plural user's colors stored on the second sub storage part 276 are received from the mode addition part 286, the controller part 290 allows the user's palette comprising the given number of user's preference colors selected to be generated and then the generated user's palette to be stored on a predetermined area in the second sub storage part 276. Along with this, the controller 290 processes the user's color mode corresponding to the user's palette generated so that it may be added to the plurality of color modes.

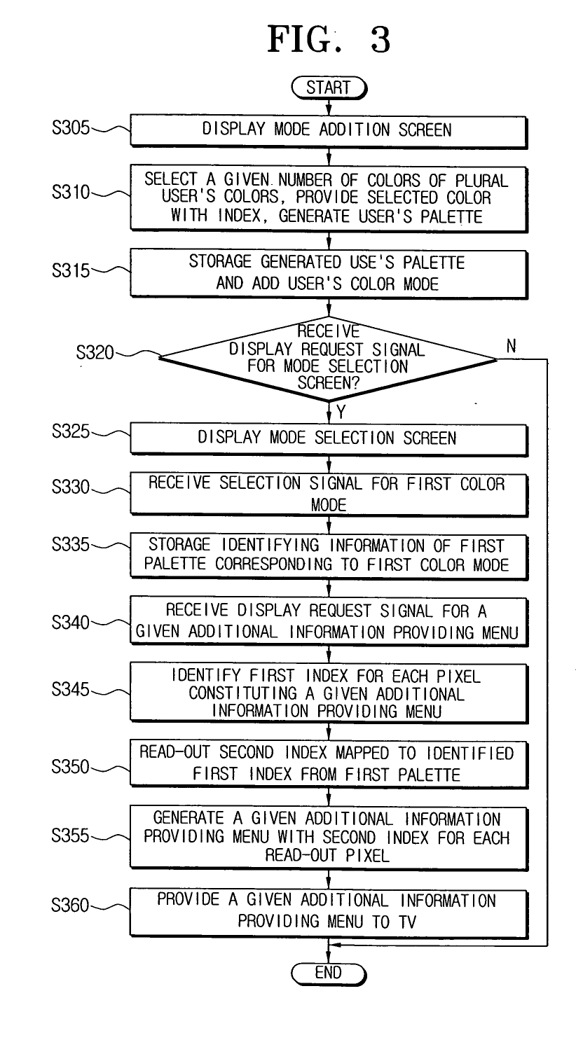

FIG. 3 is a flow chart illustrating the data processing method using the optical reproducing apparatus shown in FIG. 2.

With reference to FIG. 1 to FIG. 3, when the display request signal for the additional mode screen (not shown) is received from the display request part 284, the controller 290 generates a mode additional screen (not shown) by controlling the playback processing part 230 and the menu processing part 250, and then allows the generated mode additional screen (not shown) to be displayed on TV 10 at step S305. The mode additional screen (nor shown) displayed on TV 10 is the user's palette showing the plurality of user colors (that is, actual colors) to the user.

When a given number of user preference colors of the plurality of user colors displayed on TV 10 are selected by the mode addition part 286, and the given index is added to the respective user's preference colors selected, a single user's palette is generated at step S310.

Each of the index may randomly be provided by operating the key operation part 280 by the user, or may be sequentially provided according to the selection order of the user's preference color. In accordance with an embodiment of the present invention, since 16 colors are set for one palette, the user selects 16 user preference colors using the mode addition part 286, and then provides the selected color with a given index. More specifically, the given number of user's preference colors selected are provided with any one index of #1 through #16, and the same user's preference colors may be provided with same indexes or different indexes. For example, if a given information menu is intended to display one color, the user selects a single user's preference color 16 times, and then provides the indexes identical to the plural first indexes comprising the given information menu with the selected user's preference color.

When the user's palette is generated, the controller 290 allows the generated user's palette to be stored on the second storage part 276, and adds a user's color mode corresponding to the generated user's palette to the plural color modes at step S315.

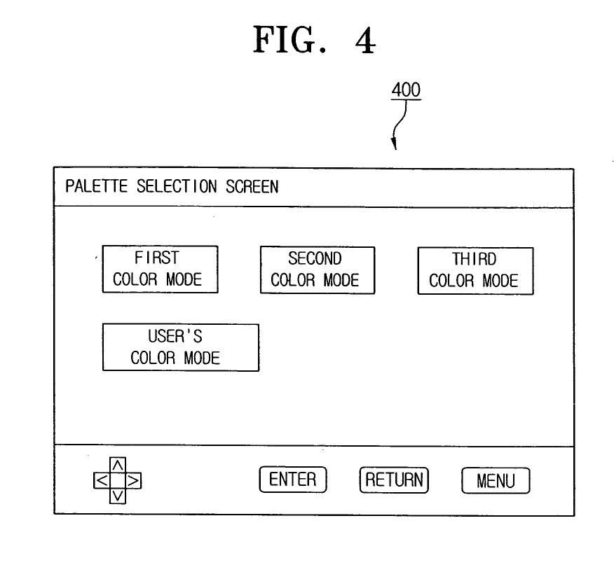

After the lapse of a given time, when the display request signal for the mode selection screen 400 is received from the display request part 284, the controller 290 generates the mode selection screen 400 as shown in FIG. 4 by controlling the menu processing part 250 and the playback processing part 230, and then allows the generated mode selection screen 400 to be displayed on TV 10 at steps S320, and S325. The mode selection screen 400 shown in FIG. 4 is a screen capable of selecting and/or setting the color mode implementing the colors of the information screen.

After step 325, with the user's key operation, when a selection signal for a given color mode (hereinafter, referring to as “a first color mode”) is received from the mode selection part 282, the controller 290 processes the identifying information of a first palette corresponding to the first color mode selected (for example, the position where the first palette is stored) so that it may be stored in the second sub storage part 276 at steps S330, S335.

After step 335, when a specific information menu, for example, a display request signal for a CD guide menu is received, the controller 290 identifies a first index for each pixel comprising the specific information menu at steps S340, S345. And, the controller 290 reads out the second indexes mapped to each of the identified first index from the second sub storage part 276 having the first palette stored at step S350.

When the step 350 is performed, the controller 290 generates a specific information menu with the color corresponding to each of the second indexes read out by controlling the menu processing part 250 and the playback processing part 230, and then processes the generated menu so that it may be provided to TV 10 at steps S355, and S360. Thereby, on TV 10, the specific information menu implemented as the first color mode selected at step 330 is displayed.

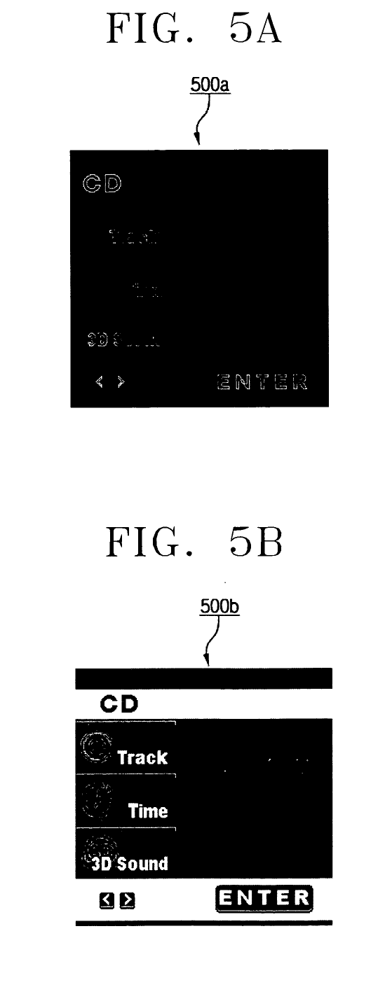

FIG. 5A is a diagram illustrating an example of an information menu implemented as the first color mode set in FIG. 2, and FIG. 5B is a diagram illustrating an example of an additional information providing menu implemented as the second color mode set in FIG. 2.

The first color mode is a mode for making the information menu darker, as compared to the second color mode. Accordingly, if the first color mode is selected in step 330, the additional information providing menu 500A displayed in step 360 of FIG. 4 is implemented as a darker screen as shown in FIG. 5A. On the other hand, if the second color mode is selected in step 330, the additional information providing menu 500B displayed in step 360 of FIG. 4 is implemented as a brighter screen as shown in FIG. 5B, as compared to FIG. 5A.

Therefore, if TV 10 is connected to the optical reproducing apparatus 200 which is a CRT TV in accordance with an embodiment of the present invention, and the palette corresponding to the first color mode of the plural color modes is set to a darker color as compared to the palette corresponding to the second color mode, if the information menu is displayed with the first color mode, it is possible to overcome the flickering generated in TV 10.

Also, if TV 10 is connected to the optical reproducing apparatus 200 which is a LCD TV, and the palette corresponding to the first color mode of the plural color modes is set to a darker color as compared to the palette corresponding to the second color mode, if the information menu is displayed with the second color mode, it is possible to display a high quality and defined information menu. That is, in the case where the color format of the information menu is converted from RGB to YIQ and output, it is possible to improve the user's viewing convenience by adjusting the bright and darkness, or the color tone of the information menu in consideration of TV 10 being connected to the optical reproducing apparatus 200.

In addition, in accordance with an embodiment of the present invention, although the present embodiments of the present invention have been described as the color format of the optical reproducing apparatus 200 being converted from RGB to YIQ, the present invention is not limited to this feature. For example, the present invention is applicable to the case where the color format is converted from RGB to RGB, or from RGB to YC, and so on.

The data processing apparatus in accordance with an embodiment of the present invention is applicable to the optical reproducing apparatus 200 described above as well as a digital contents receiver such as a Personal Video Recorder (PVR) and TV (not shown) capable of processing a signal. The digital content receiver is a type of set top box wherein moving image data received from the external image source is processed so that it may be reproduced and provided to TV 10.

As described so far, in accordance with the data processing apparatus and method in accordance with embodiments of the present invention, in a case the color format of the information menu is converted and output, in consideration of a TV connected to the data processing apparatus, it is possible to overcome the flickering generated in the TV by selecting and converting the color mode (that is, palette) of the information menu. Also, it is possible to display the information menu with a desired color by generating a given user's palette according to the user's preference.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A data processing apparatus for processing image data and an information menu which are supplied from a predetermined image source into a reproducing signal, comprising:
a key operation part for outputting a selection signal for a first mode of a plurality of color modes set and a display request signal for the additional information providing menu in order to implement the information menu,;
a first storage part for storing first indexes provided for each pixel displaying the information menu;
a second storage part for storing for each color mode a plurality of palettes comprising second indexes mapped to each of the first indexes;
a menu processing part for generating the information menu as a displayable signal; and
a controller, wherein, when the selection signal for the first mode is received, the controller stores identifying information for the palette mapped to the selected first mode in the second storage part; and when the display request signal is received, the controller reads the second indexes mapped to the first indexes from a palette corresponding to the stored identifying information and then generates the information menu with colors corresponding to the second indexes read by controlling the menu processing part.

2. The apparatus as claimed in claim 1, wherein the additional information providing menu is implemented as any one of a On Screen Display (OSD) menu and a graphical user interface (GUI) menu.

3. The apparatus as claimed in claim 1, wherein the first indexes are given a color implemented as a Red Green Blue (RGB) format, and the second indexes are given a color implemented as a luminance information and chrominance information (YIQ) format.

4. The apparatus as claimed in claim 1, wherein the second storage part further stores a user's palette comprising a plurality of user colors selected according to the user's preference,
when selecting signals for a given number of the user's preference colors from the plurality of user colors stored are received from the key operation part, the controller allows the user's palette comprising the given number of user's preference colors selected to be stored in the second storage part, and processes a user's color mode corresponding to the user's palette so that it may be added to the plurality of color modes.

5. The apparatus as claimed in claim 1, wherein the predetermined image source comprises at least one of an optical disc, a digital satellite broadcasting system, and a terrestrial wave broadcasting system.

6. A data processing method for processing a certain image data and an information menu supplied from a predetermined image source as a reproducing signal, comprising steps of:
receiving a selection signal for a first mode of a plurality of color modes set in order to implement the information menu displayed as a plurality of pixels each having a first index;
storing identifying information of palette mapped to the selected first mode of a plurality of palettes stored for each of the plurality of color modes;
reading each of second indexes mapped to the each first indexes provided for each color of the pixels from palette corresponding to the stored identifying information when a display request signal for the information menu is received; and
generating the information menu as a displayable signal using the read second indexes.

7. The method as claimed in claim 6, wherein the additional information providing menu is implemented as any one of On Screen Display (OSD) menu and a graphical user interface (GUI) menu.

8. The method as claimed in claim 6, wherein the first indexes are indexes that are given a color implemented as a Red Green Blue (RGB) format, and the second indexes are indexes that are given a color implemented as a luminance information and chrominance information (YIQ) format.

9. The method as claimed in claim 6, further comprising the steps of:
receiving selection signals for a given number of a user's preference colors from a plurality of user colors including colors corresponding to the plurality of second indexes;
storing a user's palette comprising the given number of the user's preference colors selected; and
adding a user's color mode corresponding to the user's palette to the plurality of color modes.
